(19) United States
(12) Patent Application Publication
(10) Pub. No.: US 2003/0194536 A1
(43) Pub. Date: Oct. 16, 2003

(54) Sheet for protecting purposes

(75) Inventor: Patrik Gerger, Upplands Vasby (SE)

Correspondence Address: YOUNG & THOMPSON, 745 SOUTH 23RD STREET 2ND FLOOR, ARLINGTON, VA, 22202

(73) Assignee: TOLLCO AB, Knivsta (SE)

(21) Appl. No.: 10/412,574

(22) Filed: Apr. 14, 2003

(30) Foreign Application Priority Data
Apr. 16, 2002 (SE) 0201139-3

(51) Int. Cl. B32B 3/28

(52) U.S. Cl. 428/167

(57) ABSTRACT

The invention relates to a sheet (1) intended for protecting purposes, comprising a bottom-forming part and a number of wall-forming edge portions, which each individually are foldable, via a scoring serving as a hinge, between a starting position in the same plane as the bottom part, and a folded-up position at an angle to the bottom part for forming a wall (6, 7). Characteristic of the invention is that in the area of an individual edge of the sheet, a set of several of parallel scorings (10, 12) that are placed close to each other is arranged, and an arbitrary scoring of which may be selected in order to form a hinge between the bottom part and a wall. In the area of a corner of the sheet, the individual scoring set (9) is intersected by at least one single, transverse scoring (8), secondary scorings extending from the intersection points between the transverse scoring (8) and the various, primary scorings (10) in the scoring set (9) at an acute angle to the primary scorings, in order to facilitate formation of two triangular joint sections, overlapping each other, in connection with a corner between two folded-up walls (6, 7).

### TECHNICAL FIELD OF THE INVENTION

This invention relates to a sheet intended for protecting purposes, comprising a bottom-forming part and a number of wall-forming edge portions, being individually foldable via a scoring serving as hinges, more specifically between a starting position in the same plane as the bottom part, and a folded-up position at an angle to the bottom part for forming a wall.

### PRIOR ART

By the Swedish patents SE 9303257-1 and SE 9403370-1, as well as the Swedish registrations of design 51 093 and 56 357, generally sheet-shaped drip-proof insets are previously known. The drip-proof inset accounted for in SE 9403370-1 is intended to be placed at the bottom of a kitchen sink bottom cupboard and has the purpose of intercepting possible dripping seepage water from the proper kitchen sink and leading the water forth towards the front of the kitchen sink bottom cupboard with the purpose of making also small water leakages visible. For this purpose, the inset is manufactured from on one hand a bottom, and on the other hand a U-shaped border surrounding the same, which includes two side pieces and a back piece. The drip-proof inset that is the subject of SE 9303257-1 is in the form of an underlay intended to be applied under such white goods machines as refrigerators and freezers. Also in this case, the drip-proof inset has the purpose of intercepting dripping water and leading the same forth to a visible area in front of the refrigerator or freezer. The drip-proof insets that are shown in D reg. nos. 51 093 and 56 357 likewise consist of underlays for white goods machines.

Common for the drip-proof insets mentioned above is that the same are manufactured from plastic that is formed, e.g. vacuum-formed, in one single continuous piece, the back and side pieces of the inset protruding approximately perpendicularly from the inset with the back piece permanently united with the side pieces in uniting corner portions. After the manufacture, the inset has an invariable surface area that is fairly large. Thus, the bottom of the inset may have a surface area of approximately 500×600 mm in order for the inset to fit in under, for instance, a refrigerator, a freezer or a stove (other measurements do also occur). This comparatively large surface area, in combination with the upright back and side pieces, gives rise to difficulties in connection with the insets being distributed to different purchasers. Delivery of large quantities of the insets to large-scale purchasers, such as real estate companies, housing co-operatives or the like, may per se be carried out in a reasonable way in that the insets may then be loaded and transported in large quantities on loading pallets or the like. Considerably greater difficulties arise, however, on those occasions when occasional or a few insets are to be delivered to small purchasers, such as individual house owners or apartment households. In such cases, the insets have to be packed individually in packagings that are at least as large as the proper inset and be sent to the purchaser by mail or the like. This means that the freight charge becomes disproportionately high in comparison with the cost of the proper inset. Another and at times bigger problem is the fact that that the surface area of the inset is of such dimension that the inset, in the packaged state thereof, cannot be put in letter boxes or delivered via the letter drop. The consequence of this may easily be that individual, potential users of the insets refrain from acquiring the product although the same in an effective way counteracts damages caused by damp that are insidious and difficult to trace in the floor and floor cupboards.

With the purpose of obviating the above-mentioned drawbacks of the previously known drip-proof insets, an improved insert has recently been developed, which is commercially available and the subject of SE 0103172-3. This inset initially has the shape of a plane sheet including a number of scorings, more precisely three, two of which being possible to fold up in order to form two opposite side pieces or side walls, while a third scoring may be folded up at an angle to the sheet in order to form a back piece that may be connected to the side pieces. A similar drip-proof inset is furthermore known by GB 2 269 528. Like the inset according to SE 0103172-3, this inset initially has the shape of a plane sheet having simple scorings that are located at a distance from, and parallel to, the edges of the sheet. Via these scorings, wall-forming, peripheral portions may be folded up in order to form three or even four walls.

Common for the insets or protecting sheets previously known by SE 0103172-3 and GB 2 269 528 is that the individual wall may be folded up along one single scoring with a predetermined location in the sheet. Thus, the two side walls are folded up around simple scorings, the distance of which from each other decides the width of the completed protecting inset. In an analogous way, the distance between the inset's front edge and a rear, simple scoring for folding-up a rear wall decides the length of the completed inset. This means that the completed protecting inset can only be applied in spaces (e.g. bottom cupboards of kitchen sinks, stove spaces, refrigerator spaces, etc.) of very exact dimensions. In practice, however, spaces are found the dimensions of which do not fit exactly with the predetermined width and length dimensions, respectively, of the protecting inset. This may result in the fact that the protecting inset cannot be installed in the intended space at all.

### OBJECTS AND FEATURES OF THE INVENTION

The present invention aims at obviating the above-mentioned shortcomings of the previously known protecting insets or sheets of the kind in question. Therefore, a primary object of the invention is to provide a protecting sheet, the dimensions of which—preferably both the width and length dimensions—easily may be adapted to unintentional dimensional deviations of the space in which the protecting sheet is to be mounted. An additional object is to provide a protecting sheet, the different walls of which may be folded up and edgewisely connected in a simple and convenient way. It is also an object to provide a protecting sheet, the folded-up side walls of which in a simple way may be made of uniform height, even if the width and length dimensions, respectively, of the sheet after adaptation to the dimensions of the space in question differ from the nominal standard dimensions. It is also an object to provide a protecting sheet that is possible to use not only as a drip-proof inset, but also for other purposes, e.g. such as bottoms in drawers or the like.

According to the invention, at least the primary object is attained by the features defined in the characterizing clause of claim 1. Preferred embodiments of the invention are furthermore defined in the dependent claims 2-4.

### SUMMARY OF THE INVENTION

The invention is based on the idea of forming sets of scorings that are located close to each other along the edge areas of a plane sheet. In this way, a suitable scoring in each set may be selected to form a hinge for folding-up a wall at an angle to the bottom part of the sheet. Thereby, the width and length, respectively, of the bottom part may be varied and adjusted to the actual width and length dimensions, respectively, of the space in which the sheet is to be mounted. In order to form a watertight corner between two walls oriented at an angle to each other, triangular joint sections, overlapping each other, are furthermore formed by folding the sheet material around a specific secondary scoring, viz. an inclined scoring extending from an intersection point between a selected, primary scoring and a transverse scoring.

### FURTHER ELUCIDATION OF PRIOR ART

By U.S. Pat. No. 2,756,463, a structural panel is previously known, which is put together by a trough-like bottom part and a cover sheet while forming a closed box, in which a heat insulating material is housed. The trough-like bottom part initially has the form of a plane sheet, in which notches or scorings are formed, by means of which it is possible to fold up upright walls as well as folded-in flanges at the upper edges of the walls. For this purpose, two parallel notches are arranged in connection with each outer edge of the sheet. The innermost of said two notches serves as a hinge for the individual wall, while the outermost notch serves as a hinge for folding-in the flange. This means that the trough that is formed through folding-up the side walls always obtains one and the same width and length dimensions, respectively. In spite of the occurrence of two notches in connection with each outer edge, the dimensions of the sheet can therefore not be varied.

### BRIEF DESCRIPTION OF THE APPENDED DRAWINGS

In the drawings:

FIG. 1 is a planar view of a protecting sheet according to the invention in a plane, initial state,

FIG. 2 is a perspective view of a drip-proof inset, made from the protecting sheet according to FIG. 1, the excess material from three edge areas being shown separated from the inset,

FIG. 3 is an enlarged detailed planar view showing a first corner portion of the sheet according to FIG. 1,

FIG. 4 is a second detailed planar view showing another corner portion of the sheet,

FIG. 5 is a perspective view showing the protecting sheet according to FIG. 1 laid out in front of a kitchen sink cupboard,

FIG. 6 is a partial perspective view showing a corner portion in connection with an individual mounting step,

FIG. 7 is a perspective view of a corner portion during two additional mounting steps,

FIG. 8 is a partial perspective view showing an additional mounting step,

FIG. 9 is a perspective view showing the completed protecting inset mounted in the kitchen sink bottom cupboard,

FIG. 10 is a planar view of an alternative embodiment of a protecting sheet according to the invention, and

FIG. 11 is an exploded view in perspective, showing an inset for a sliding drawer, made from the sheet according to FIG. 10.

### DETAILED DESCRIPTION OF PREFERRED EMBODIMENTS OF THE INVENTION

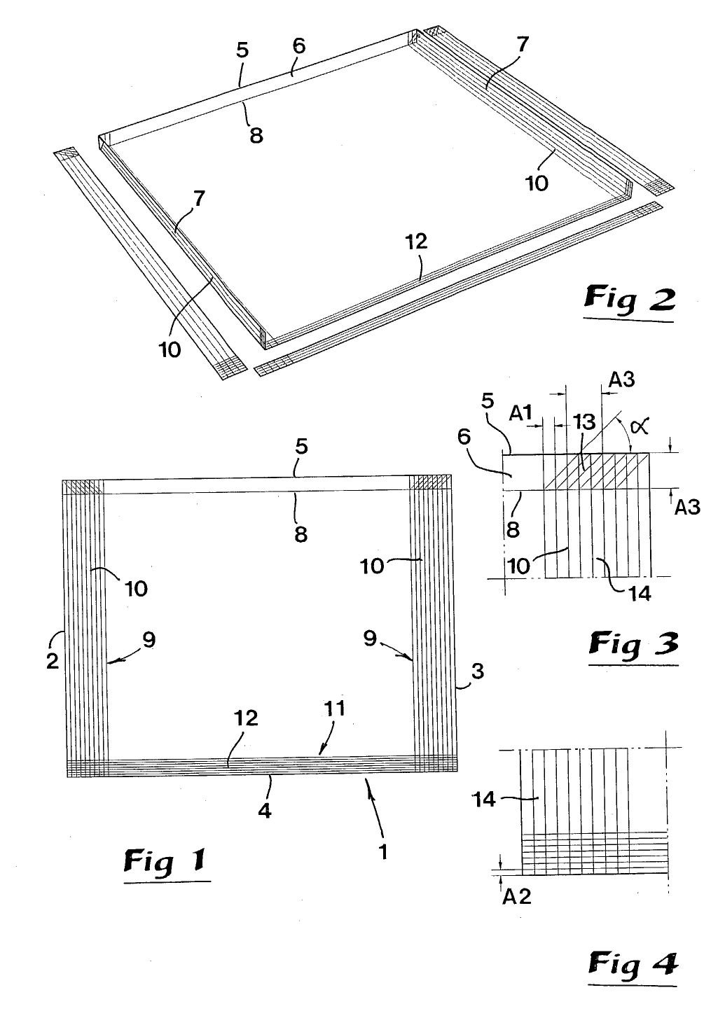

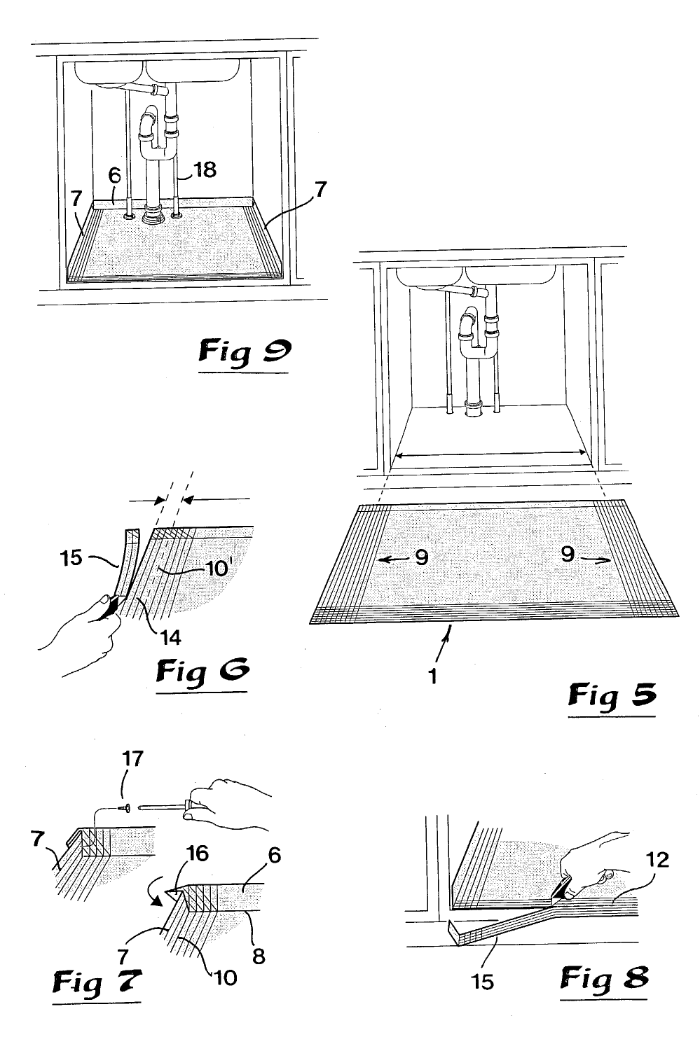

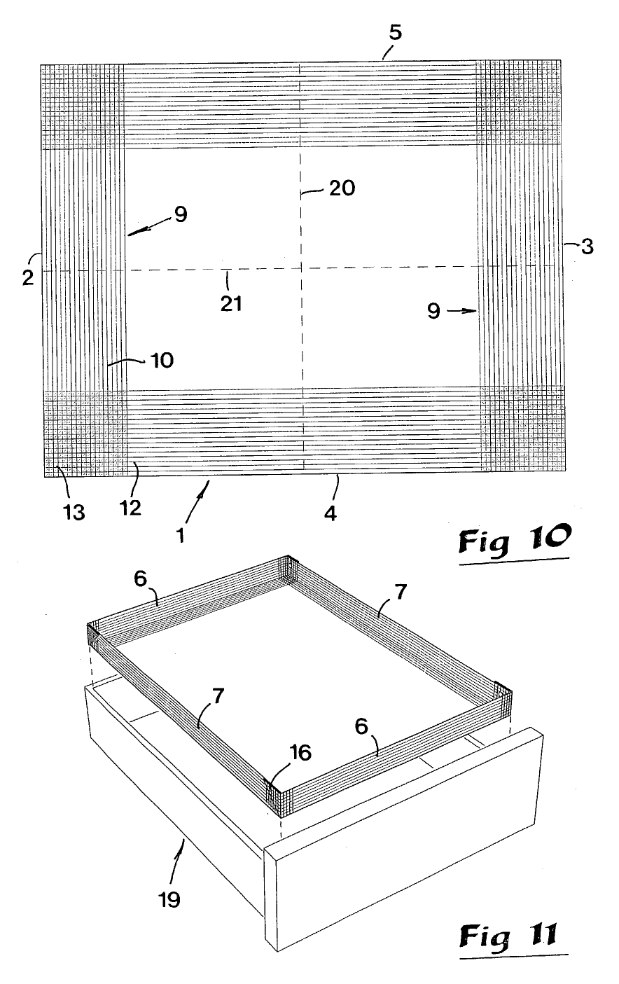

In FIGS. 1-4, a sheet 1 of a quadrangular basic shape is illustrated. The sheet is delimited by four straight edges 2, 3, 4 and 5, which are parallel in pairs. Thus, the angle between the edges is 90° where nearby edges meet each other in a corner. In the illustrated embodiment, the sheet is rectangular, although the same may also be square or in another way quadrangular.

In FIG. 2, a completed drip-proof inset is shown such as the same is at hand after machining of the initially plane sheet according to FIG. 1. As is seen in FIG. 2, the inset in this case includes folded-up walls along three of the four edge areas thereof, more precisely a rear wall 6 and two side walls 7. In the folded-up state according to FIG. 2, the walls 6, 7 jointly form a U-shaped border that is held together at two rear corners.

In a way known per se, the rear wall 6 is foldable around a single simple scoring 8 extending in parallel with the rear edge 5 of the sheet 1. More precisely, the scoring 8 extends all the way between the two opposite side edges 2, 3 of the sheet.

Characteristic of the invention is that the sheet 1 in the area of the other edges 2, 3, 4 has sets of a plurality of scorings. Thus, first scoring sets, generally designated 9, are formed in connection with the side edges 2, 3, each one of which sets includes a plurality of straight and mutually parallel scorings 10. The scorings 10 extend all the way between the front and rear edges 4 and 5, respectively, of the sheet. The number of scorings 10 in each scoring set 9 may vary, per se, but should amount to at least five and at most ten. In the shown example, nine scorings 10 are included in each set 9. The different scorings 10 in the individual set 9 are most suitably located at equally large distances from each other. Said distance should amount to at least 3 mm and at most 12 mm, suitably at least 5 mm and at most 10 mm.

In connection with the front edge 4 of the sheet, a second set 11 of straight, mutually parallel scorings 12 is formed, which individually suitably extends all the way between the side edges 2, 3 of the sheet. Also in this case, the distance between nearby scorings in the set should be equally large. However, in the concrete embodiment example, the distance between the scorings 12 is smaller than the corresponding distance between the scorings 10 in the scoring sets 9. Thus, the distance A1 (see FIG. 3) between the scorings 10 may be 10 mm, while the distance A2 (see FIG. 4) between the scorings 12 may be 5 mm. The number of scorings 12 in the set 11 amounts to seven. The width of the set 11, counted from the front edge 4 to the innermost scoring, then amounts to 35 mm, while the width of the scoring set 9, counted from the innermost scoring to an outer side edge 2 and 3, respectively, amounts to 90 mm. The distance A3 deciding the height of the rear wall 6, is in the example assumed to amount to 30 mm.

The sheet according to the invention is suitably made from plastic and has advantageously a thickness that does not exceed 1 mm. In practice, the sheet may be manufactured from, for instance, polypropylene, and have a thickness of 0.8 mm. The individual scorings in the sheet are linear and may be brought about in various ways by means of known technique. For instance, the scoring may consist of a weakening in the form of a simple notch or flute in one side of the sheet. Most preferable, however, are pairs of notches that are hobbed or in another way formed at opposite sides of the sheet, a narrowed, central waist being left in the sheet. If the thickness of the sheet is 0.8 mm, the waist may for instance have a thickness of 0.2 mm, and the notches at opposite sides of the waist may have a depth of 0.3 mm.

Reference is now made to FIGS. 3 and 4, which in an enlarged state illustrate how the sheet is constructed in the area of rear and front corners. Thus, it is shown in FIG. 3 how a secondary scoring 13 extends from each intersection point between the transverse single scoring 8 and each individual primary scoring 10 in a scoring set 9 at an acute angle α to the scoring 8. Said angle α amounts to 45°. By the existence of the secondary scorings 13, forming of triangular tongues 16 overlapping each other for forming of connecting corners is facilitated, as is shown in FIG. 7.

In FIG. 3, it is furthermore illustrated how the height of the rear wall 6, such as this is represented by the distance between the rear edge 5 of the sheet and the single scoring line 8, corresponds to a predetermined number of laminated portions 14, in this case three, between nearby scorings 10. Assume that the height 6 of the wall should amount to 30 mm and that the distance A1 between nearby scorings 10 amounts to 10 mm. Then, the height A3 of the wall 6 corresponds to the total width A3 of three laminated portions 14.

In the front corner area that is shown in FIG. 4, inclined, secondary scorings are missing by the embodiment in question of the protecting sheet should being used as a drip-proof inset that is open in the forward direction.

Reference is now made to FIGS. 5-9, which illustrate different steps in connection with the completion and mounting of a drip-proof inset for kitchen sink bottom cupboards. In FIG. 5, an entirely plane sheet 1 is shown laid out on the floor in front of a kitchen sink bottom cupboard. In a first step, the actual width and depth (or length) of the bottom cupboard is measured. When the width of the bottom cupboard has been determined, the measurement is transferred to the sheet, two scorings in the scoring sets 9 being selected in order to form hinges or folding lines around which the side walls 7 of the inset may be folded up. In FIG. 6, such a scoring is shown by means of a dashed line, designated 10′. When the scoring 10′ has been selected, occurring excess material in the form of a strip 15 is cut away from the sheet. If the rear wall 6 has a predetermined height of 30 mm, three laminated portions 14 outside the scoring 10′ are kept, and then the remaining two laminated portions are cut off.

In the next step, illustrated in FIG. 7, the walls 6, 7 are folded up around the scorings 8, 10′, and then a corner, uniting the walls, is provided. This is carried out by the fact that two triangular tongues 16, delimited by secondary, inclined scorings 13, are put so that they overlap each other and are folded-in against the outside of the wall 7. Said tongues are then connected with the wall 7 by means of a locking member 17, e.g. a screw, a rivet, a pin or the like.

In order to exactly adapt the length of the sheet 1 to the depth of the kitchen sink bottom cupboard, a front strip 15′ may have to be cut off from the front portion of the sheet, as is shown in FIG. 8. Most suitably, the excess strip 15′ is cut off from the sheet only when the same has been brought into the kitchen sink bottom cupboard. The cutoff is carried out by the individual scoring 12 that after insertion of the sheet into the bottom cupboard is closest to the front edge of the bottom of the bottom cupboard.

Reference being made to FIG. 9, it should also be mentioned that individual holes and slots may need to be cut out from the sheet in order to permit housing of through, vertical pipes 18 of the type that conventionally are found under kitchen sinks. When the protecting sheet has been applied in the bottom cupboard, the same forms a forwardly open trough that forces possibly occurring seepage water to run out over the front edge of the sheet in order to be made visible on the floor in front of the kitchen sink bottom cupboard. In this connection, it should be pointed out that not only the three scorings around which the walls 6, 7 have been folded up, but also the corner joints between the walls, are watertight.

In FIGS. 10 and 11, an alternative embodiment is shown according to which the protecting sheet 1 is formed to be able to form a protective bottom inset in a drawer 19, e.g. a sliding drawer. In this case, the sheet includes four scoring sets 9, 11 in order to permit folding-up of four walls 6, 7 at variable distances from each other. In all four corner areas, the sheet has not only individual scorings 10, 12, intersecting each other at a right angle, but also secondary scorings 13, extending at an angle of 45° to the scorings 10, 12. In this way, all four corners may be formed with uniting, triangular tongues 16.

In FIG. 10, it is outlined by dashed lines how the sheet 1 also may be formed with two additional scorings 20, 21. Of these, the scoring 20 is placed approximately halfway between the two side edges 2, 3 of the sheet, the scoring being parallel to said edges. In an analogous way, the scoring 21 is placed halfway between the front and rear edges 4, 5 of the sheet. The two halves of the sheet that are present on both sides of the scoring 20 may be folded towards each other so as to halve the superficial area or projection area of the sheet. In a second step, the folded sheet may be folded an additional time, viz. around the scoring 21. By folding the sheet two times in this way, the superficial area of the sheet may be reduced to ¼ of the initial superficial area of the sheet in a plane state.

A primary advantage of the invention is that the width and length dimensions of the initially plane sheet may be accurately adapted to the actual dimensions of the space in which the completed protecting inset is to be applied.

### FEASIBLE MODIFICATIONS OF THE INVENTION

The invention is not solely limited to the embodiments described above and illustrated in the drawings. Thus, it is possible to arrange a scoring set having a plurality of mutually parallel scorings also in the area of the rear edge area of the protecting sheet, shown in FIGS. 1-9. In this way, the height of the rear wall 6 of the protecting inset may be varied as desired. It should also be mentioned that the sheet in connection with the two side edges 2,3 may be formed with a scoring set having a plurality of scorings, as well as a single scoring that provides a side wall of a predetermined height, the adaptation of the width dimensions being carried out by selecting a suitable fold scoring in the set of several scorings.

1. A sheet for protecting purposes, comprising a bottom-forming part and a number of wall-forming edge portions, being individually foldable, via scorings (8, 10, 12) serving as hinges, more specifically between a starting position in the same plane as the bottom part, and a folded-up position at an angle to the bottom part for forming a wall (6, 7), wherein in the area of an individual edge (2, 3, 4) of the sheet (1) there is arranged a set (9, 11) of several, parallel scorings (10, 12) that are placed close to each other, an arbitrary scoring thereof being selectable in order to form a hinge between the bottom part and a wall, and that the individual scoring set (9) in the area of a corner of the sheet is intersected by at least one single, transverse scoring (8, 12), secondary scorings (13) extending from the intersection points between the transverse scoring and the various, primary scorings (10) in the scoring set (9) at an acute angle (α) to the primary scorings, in order to facilitate formation of two triangular joint sections (16), overlapping each other, in connection to a corner between two folded-up walls (6, 7).

2. A sheet according to claim 1, wherein that the scorings (10, 12) in the individual scoring set (9, 11) are located at equally large distances from each other.

3. A sheet according to claim 2, wherein the distance between nearby scorings (10 and 12, respectively) amounts to at least 3 mm and at most 12.

4. A sheet according to claim 1, wherein the number of scorings (10, 12) in the individual scoring set (9, 11) amounts to at least five and at most ten.
